(19) United States
(12) Patent Application Publication
(10) Pub. No.: US 2026/0316721 A1
(43) Pub. Date: Oct. 15, 2026

(54) CLEANING DEVICE

(71) Applicant: A. Raymond et Cie, Grenoble (FR)

(72) Inventors: Karl Bode, Lörrach (DE); Daniel Schreiyäck, Weil am Rhein (DE); Jan Regensburger, Kandern (DE); Niklas Mente, Lörrach (DE)

(21) Appl. No.: 19/576,361

(22) Filed: Mar. 24, 2026

(30) Foreign Application Priority Data
Apr. 9, 2025 (FR) FR2503770

(51) Int. Cl. B60S 1/56; B60S 1/52; B60S 1/54

(52) U.S. Cl. CPC B60S 1/56; B60S 1/52; B60S 1/54

(57) ABSTRACT

A cleaning device is configured to dispense two fluids, respectively, a first fluid and a second fluid. The cleaning device includes, alternatively disposed along a main direction of a face, a spraying face, a series of first outlets and second outlets, each series of first outlets comprising first outlets, advantageously aligned along the main direction. The first outlets of a series of first outlets include main first outlets configured to spray the first fluid along a spraying direction perpendicular to the main direction and two lateral first outlets configured to spray the first fluid along, respectively, a first lateral direction and a second lateral direction, diverging from each other in a plane formed by the spraying direction and the main direction.

### CROSS-REFERENCE TO RELATED APPLICATIONS

This application claims the benefit of the filing date of French Patent Application Serial No. FR2503770, filed April 9, 2025, for “Cleaning Device,” the disclosure of which is hereby incorporated herein in its entirety.

### TECHNICAL FIELD

The present disclosure concerns a cleaning device for cleaning a surface of an exposed surface of a sensor.

Notably, the present disclosure aims at proposing a cleaning device configured for cleaning and drying large surfaces with reduced fluid consumption.

### BACKGROUND

Automotive vehicles are now equipped with many sensors, cameras, lidars or radars (hereinafter referred to as “sensors”) for driving assistance purposes. These sensors may be located inside or outside the vehicle in order to offer the driver a complete visibility of the environment in which the vehicle is located. For example, sensors may be located in the bumper, in the side-skirt, on the side mirror, behind the windshield, under the hood, nearby the headlamps, on a roof pod.

However, these sensors, when exposed to the environment, are likely to be covered with dirt or dust, and consequently may encounter performance degradations. Frequent cleaning and drying of these sensors is therefore required to guarantee their performances.

In this respect, automotive vehicles may be provided with a cleaning system equipped, in particular, with cleaning fluid distribution ducts and nozzles. The nozzles are notably arranged at the ends of the fluid distribution ducts and in close proximity of the sensors. According to this arrangement, it is possible to dispense a cleaning fluid on the surface of each of the sensors and thus remove traces of dust or dirt.

To this regard, a fluid distribution system known from the prior art is disclosed in International Patent Application Publication No. WO 2023/036383. However, the fluid distribution system disclosed in this document is not satisfactory. In fact, the liquid and gas outlets are not properly arranged to optimize the cleaning and the drying of broad surfaces and the liquid consumption. Furthermore, the system proposed in this document is not sufficiently compact.

One purpose of the present disclosure is to propose a cleaning device that allows an optimized cleaning and drying of large surfaces and reduced liquid consumption with respect the cleaning devices known from prior art.

Another purpose of the present disclosure is also to propose a cleaning device for which the cleaning efficiency is improved with respect to the cleaning devices known from prior art.

Another purpose of the present disclosure is also to propose a cleaning device that is more compact than the fluid distribution system known from prior art.

### BRIEF SUMMARY

The purposes of the present disclosure are, at least partly, achieved by a cleaning device configured to dispense two fluids respectively, a first fluid and a second fluid, the cleaning device comprising, alternatively disposed along a main direction of a spraying face spraying face, a series of first outlets and second outlets, each series of first outlets comprising first outlets, advantageously aligned along the main direction, the first outlets of a series of first outlets comprising main first outlets configured to spray the first fluid along a spraying direction perpendicular to the main direction and two lateral first outlets configured to spray the first fluid along, respectively, a first lateral direction and a second lateral direction, diverging from each other in a plane formed by the spraying direction and the main direction.

According to one embodiment, the cleaning device comprises a first inlet, and first channels, the first channels fluidically connecting the first inlet to the first outlets, advantageously, the first channels are dimensioned to ensure that the first fluid flow is essentially the same at each of the first outlets among all the series of first outlets.

According to one embodiment, the second outlets are arranged in two sets of second outlets, respectively, an even set of second outlets and an odd set of second outlets, each set of second outlets being configured to spray the second fluid independently from the other set of second outlets.

According to one embodiment, the cleaning device comprises two second inlets respectively, an even second inlet and an odd second inlet, the cleaning device also comprises two sets of second channels respectively, an even set of second channels and an odd set of second channels, the even set of second channels comprising even second distribution channels and the even set of second channels fluidically connecting the even second inlet to the even set of second outlets while the odd set of second channels fluidically connecting the odd second inlet to the odd set of second outlets advantageously, the even set of second channels is dimensioned to ensure that the second fluid flow is essentially the same at each of the second outlets of the even set of second outlets and the odd set of second channels is dimensioned to ensure that the second fluid flow is essentially the same at each of the second outlets of the odd set of second outlets.

According to one embodiment, the cleaning device comprises a stacking of at least two plates, the stacking comprising two main faces opposite to each other.

According to one embodiment, the stacking of at least two plates comprises a plastic material.

According to one embodiment, the plates are assembled so that the interface between two plates is hermetically sealed.

According to one embodiment, the at least two plates comprise, from one main face, the first face, to the other main face, the second face, a first plate, a second plate and a third plate, the stacking comprising a first interface between the first plate and the second plate, and a second interface between the second plate and the third plate.

According to one embodiment, the even set of second channels comprise even second distribution channels and an even second distribution line, the odd set of second channels comprise odd second distribution channels and an odd second distribution line.

According to one embodiment, the even second distribution line and the odd second distribution line are formed on one of the first interface and the second interface, while the even second distribution channels and the odd second distribution channels are formed on the other of the first interface and the second interface.

According to one embodiment, even second through holes are formed on the second plate to fluidically connect the even second distribution channels with the even second distribution line, and odd second through holes are formed in the second plate to fluidically connect the odd second distribution channels with the odd second distribution line.

According to one embodiment, the first channels comprise first distribution channels and a first distribution line, the first distribution line is formed on one of the first interface and the second interface, while the first distribution channels are formed on the other of the first interface and the second interface.

According to one embodiment, the first channels comprise first distribution channels and a first distribution line, the first distribution line and the first distribution channels are formed either on the first interface or on the second interface.

According to one embodiment, first through holes are formed on the second plate to fluidically connect the first distribution channels with the first distribution line.

According to one embodiment, the two second inlets and the first inlet are formed on one or the other of the first face and the second face.

According to one embodiment, the second plate comprises at least one passage fluidically connecting at least one of the two second inlets and the first inlet respectively, to the second channels and the first channels.

According to one embodiment, the stack of three plate has a thickness less than 15 mm, advantageously less than 10 mm, a length less than 200 mm, advantageously less than 180 mm, and a width less than 80 mm, advantageously less than 65 mm.

According to one embodiment, the first outlets within each series of first outlets are arranged in a periodic manner along the main direction.

According to one embodiment, the second outlets are arranged in a periodic manner along the main direction.

The present disclosure also concerns a fluid delivery assembly comprising:
at least one cleaning device according to the present disclosure;
a first fluid source; and
a second fluid source.

The present disclosure also concerns an automotive vehicle comprising at least one sensor, the sensor having an exposed surface, the sensitive surface, the automotive vehicle being provided with at least one fluid delivery assembly according to the present disclosure, wherein the at least one delivery assembly being arranged for cleaning and drying the sensitive surface.

### BRIEF DESCRIPTION OF THE DRAWINGS

Other features and advantages will be better understood after reading the following description of the cleaning device for the cleaning of surface sensor of a vehicle according to the present disclosure, provided as non-limiting examples only, with reference to the accompanying drawings in which:

FIG. 1 is a schematic illustration in perspective of the cleaning device according to the present disclosure;

FIG. 2 is an exploded perspective view of the cleaning device of FIG. 1;

FIG. 3 is a schematic perspective view of cleaning device according to the present disclosure;

FIG. 4 is a schematic view of a series of first outlets of the cleaning device according to the present disclosure;

FIG. 5 represents a cross section of a series of first outlets according to the present disclosure;

FIG. 6 illustrates the spraying of a first fluid on a surface S with a cleaning device for which the series of first outlets do not fulfill the condition imposed by the present disclosure;

FIG. 7 illustrates the spraying of a first fluid on a surface S with a cleaning device according to the present disclosure;

FIG. 8 is a perspective view of a first plate of the cleaning device of FIG. 1 in a perspective view;

FIG. 9 is a perspective view of a second plate of the cleaning device of FIG. 1 in a perspective view, and showing the odd and even second distribution lines;

FIG. 10 is a perspective view of a second plate of the cleaning device of FIG. 1 in a perspective view, and showing the odd and even second distribution channels; and

FIG. 11 is a perspective view of a third plate of the cleaning device of FIG. 1 in a perspective view, and showing the odd and even second distribution channels.

### DETAILED DESCRIPTION

The present disclosure concerns a cleaning device configured to dispense two fluids respectively, a first fluid and a second fluid, the cleaning device comprising, alternatively disposed along a main direction of a face, the spraying face, a series of first outlets and second outlets, each series of first outlets comprising first outlets, advantageously aligned along the main direction, the first outlets of a series of first outlets comprising main first outlets configured to spray the first fluid along a spraying direction perpendicular to the main direction and two lateral first outlets configured to spray the first fluid along, respectively, a first lateral direction and a second lateral direction, diverging from each other in a plane formed by the spraying direction and the main direction.

It is understood that each second outlet is disposed between two series of first outlets.

The cleaning device can dispense, independently and/or sequentially, two different types of fluids respectively, a first fluid and a second fluid. The first fluid may comprise a dry gas, for example, dry air, while the second fluid may comprise a liquid, for example, water.

In this regard, the liquid may be sprayed onto a surface sensor to remove particles or dust, while the dry gas may be sprayed onto the surface sensor to remove the liquid droplets.

Taking into account the first lateral outlets as defined above, the entire surface of the sensor can be dried efficiently. Notably, the first lateral outlets reduce the effect of the gap between two adjacent series of first outlets.

The cleaning device according to the present disclosure represents an efficient solution for the cleaning of sensor devices, and, in particular, for the cleaning of the sensor devices of automotive vehicles.

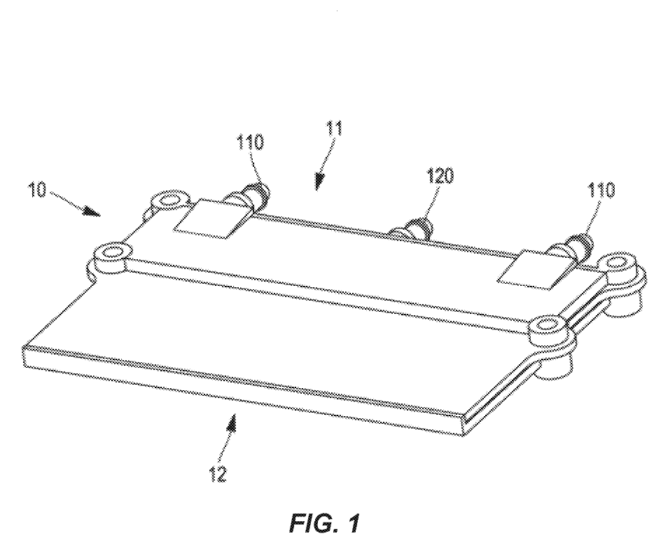

FIG. 1 is a schematic illustration of the cleaning device 10 according to a non-limiting example of the present disclosure.

The cleaning device 10 is notably configured to deliver two fluids, respectively, the first fluid and the second fluid.

For example, the first fluid may comprise a liquid while the second fluid may comprise a dry gas, for example, dry air. Notably, the cleaning device may be coupled with a first pressure tank and a second pressure tank that are configured to continuously supply to the cleaning device, respectively, the first fluid and the second fluid. Each of the tanks can deliver a fluid under pressure, and notably up to 8 bars.

The cleaning device 10, as represented in FIG. 1, may have a flat shape, and may comprise two main faces (opposite to each other), respectively, a first face 11 and a second face 12. More particularly, the cleaning device 10 can comprise a stacking of at least two plates comprising, for example, a plastic material.

Advantageously, the plates can be assembled so that the interface between two plates is hermetically sealed.

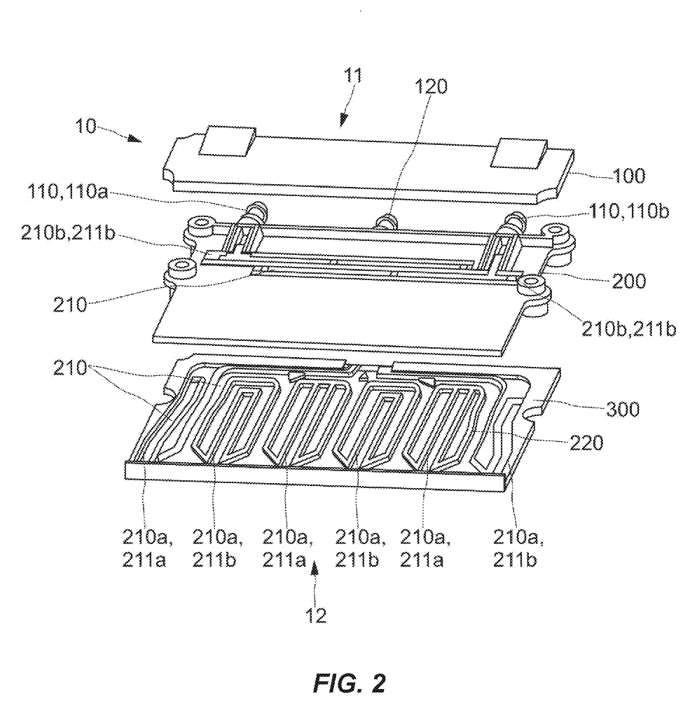

More particularly, and as shown in FIG. 2, which is an exploded view of the cleaning device of FIG. 1, the cleaning device 10 can comprise a stack of three plates, respectively, from the first face 11 toward the second face 12, a first plate 100, a second plate 200 and a third plate 300. The stacking can comprise a first interface between the first plate 100 and the second plate 200, and a second interface between the second plate 200 and the third plate 300.

It is understood, according to the present disclosure, that a plate has a generally flat shape and comprises two main faces joined by an edge.

Furthermore, the stack of three plates may have a thickness less than 15 mm, advantageously less than 10 mm, a length less than 200 mm, advantageously less than 180 mm, and a width less than 80 mm, advantageously less than 65 mm.

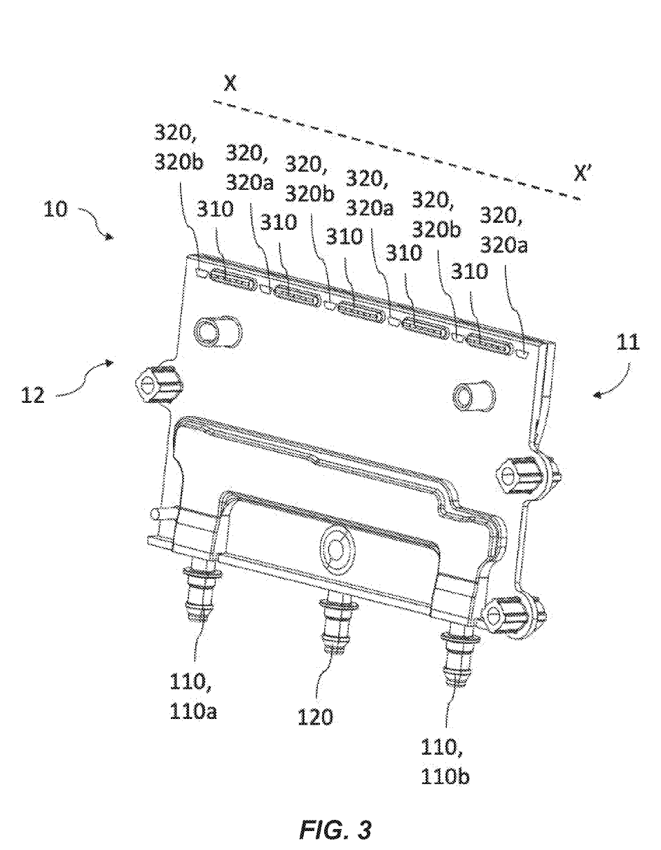

The cleaning device 10 comprises, alternatively disposed along a main direction XX′ of a face, the spraying face, a series of first outlets 310 and second outlets 320 (FIG. 3). It is understood that the spraying face can be any face or contour of the stack of plates.

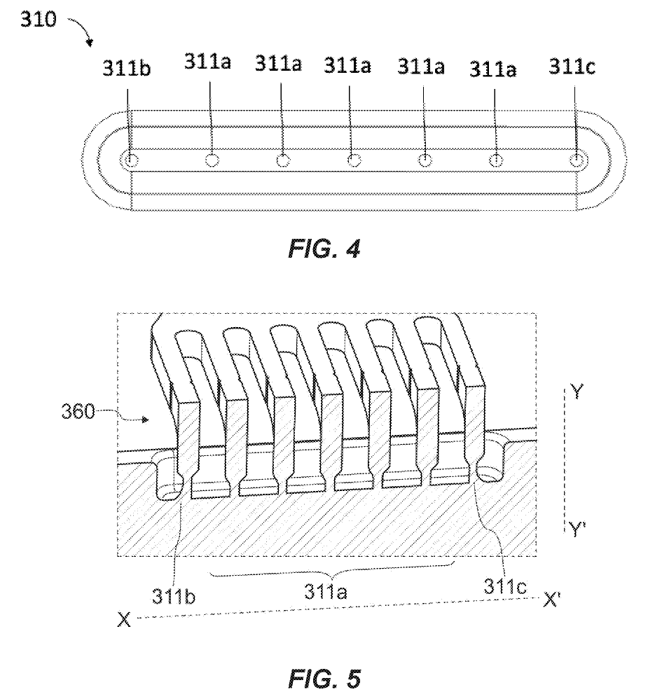

Each series of first outlets 310 comprises first outlets, advantageously aligned along the main direction XX′ (FIGS. 3-5). The first outlets of a series of first outlets 310 comprises main first outlets 311a configured to spray the first fluid along a spraying direction perpendicular to the main direction XX′ and two lateral first outlets 311b, 311c configured to spray the first fluid along, respectively, a first lateral direction and a second lateral direction, diverging from each other in a plane formed by the spraying direction and the main direction XX′.

Each second outlet 320 is disposed between two adjacent series of first outlets 310. In other words, the series of first outlets 310 and the second outlets 320 are alternatively disposed along the main direction.

The first outlets within each series of first outlets 310 can be arranged in a periodic manner along the main direction XX′.

The second outlets 320 can be arranged in a periodic manner along the main direction XX′.

The first outlets 311 can have a circular shape, and the second outlets 320 can have a circular shape or an elongated shape.

This configuration allows the first fluid to be sprayed over the entire surface without dead zones, particularly in the areas between the first series of outlets. This aspect is particularly advantageous when it comes to drying a surface with a first fluid comprising a dry gas (e.g., dry air).

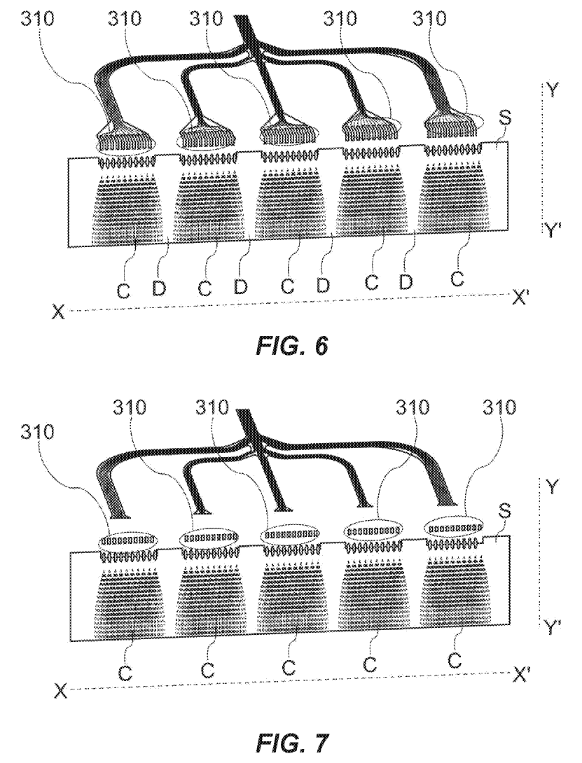

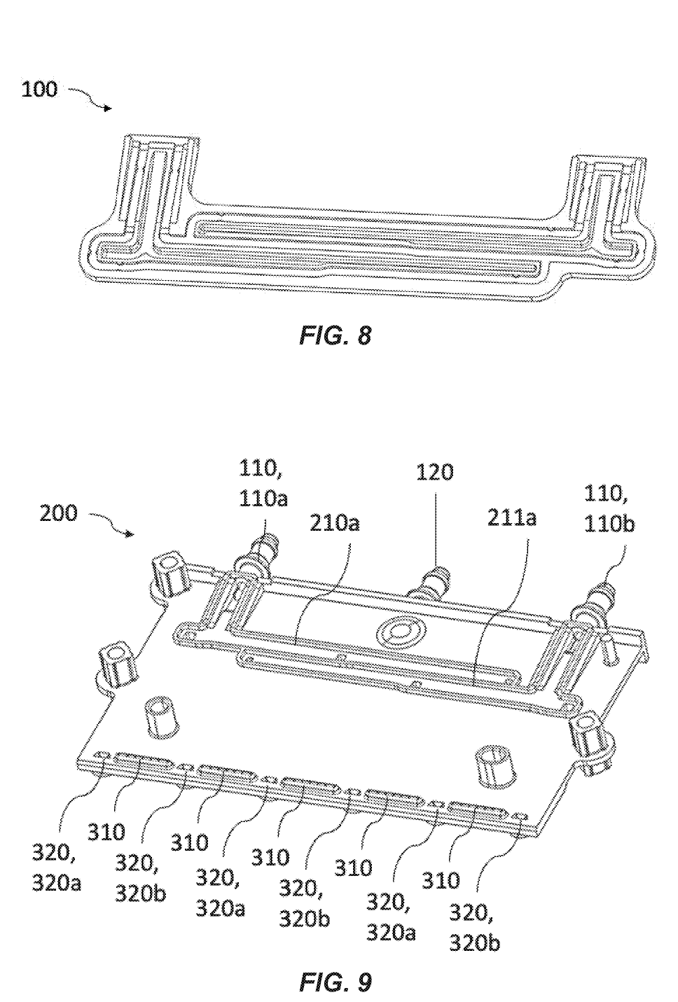

In this respect, FIG. 6 illustrates the spraying of a first fluid onto a surface S using a cleaning device for which the series of first outlets do not fulfill the condition imposed by the present disclosure. Notably, the lateral first outlets and the main first outlets are configured to spray the first fluid along the spraying direction. Clear areas C separated by dark areas D are clearly visible on the surface S. Clear areas C and dark areas D correspond to areas, respectively, reached and not reached by the first fluid. In other words, dark areas D are dead zones that could not be dried efficiently.

FIG. 7 illustrates the spraying of a first fluid onto the surface S using a cleaning device according to the present disclosure. in FIG. 7, the dark areas D have almost disappeared, indicating more efficient drying when the lateral first outlets 311b, 311c are considered.

During use, the second outlets 320 can spray a second fluid, such as water, onto the surface for cleaning, while the series of first outlets spray a first fluid, such dry air, onto the surface for drying.

As illustrated in FIG. 2, the cleaning device comprises a first inlet 120, and first channels 220, the first channels 220 fluidically connecting the first inlet 120 to the series of first outlets 310. Advantageously, the first channels 220 are dimensioned to ensure that the first fluid flow is essentially the same at each of the first outlets among all the series of first outlets. This later aspect can be achieved by adjusting the length and/or to cross-section of the first channels.

According to an advantageous embodiment, the first channels 220 can comprise first distribution channels 220b and a first distribution line 220a, the first distribution line 220a is formed on one of the first interface and the second interface, while the first distribution channels 220b are formed on the other of the first interface and the second interface. First through holes can be formed on the second plate to fluidically connect the first distribution channels 220b with the first distribution line 220a.

In a specific embodiment, the first distribution line 220a can be molded on one of the first plate 100 and the second plate 200 at the first interface, while the first distribution channels 220b can be molded on one of the second plate 200 and the third plate 300 at the second interface.

The second outlets 320 can be arranged in two sets of second outlets, respectively, an even set of second outlets 320a and an odd set of second outlets 320b, each set of second outlets being configured to spray the second fluid independently from the other set of second outlets. Advantageously, second outlets of the even set of second outlets 320a and second outlets of the odd set of second outlets 320b are alternatively disposed along the main direction XX′.

Advantageously, the cleaning device can comprise two second inlets 110, respectively, an even second inlet 110a and an odd second inlet 110b, the cleaning device can also comprise two sets of second channels, respectively, an even set of second channels 210 and an odd set of second channels 211, the even set of second channels fluidically connecting the even second inlet 110a to the even set of second outlets 320a while the odd set of second channels fluidically connecting the odd second inlet 110b to the odd set of second outlets 320b.

The even set of second channels is dimensioned to ensure that the second fluid flow is essentially the same at each of the second outlets of the even set of second outlets and the odd set of second channels is dimensioned to ensure that the second fluid flow is essentially the same at each of the second outlets of the odd set of second outlets.

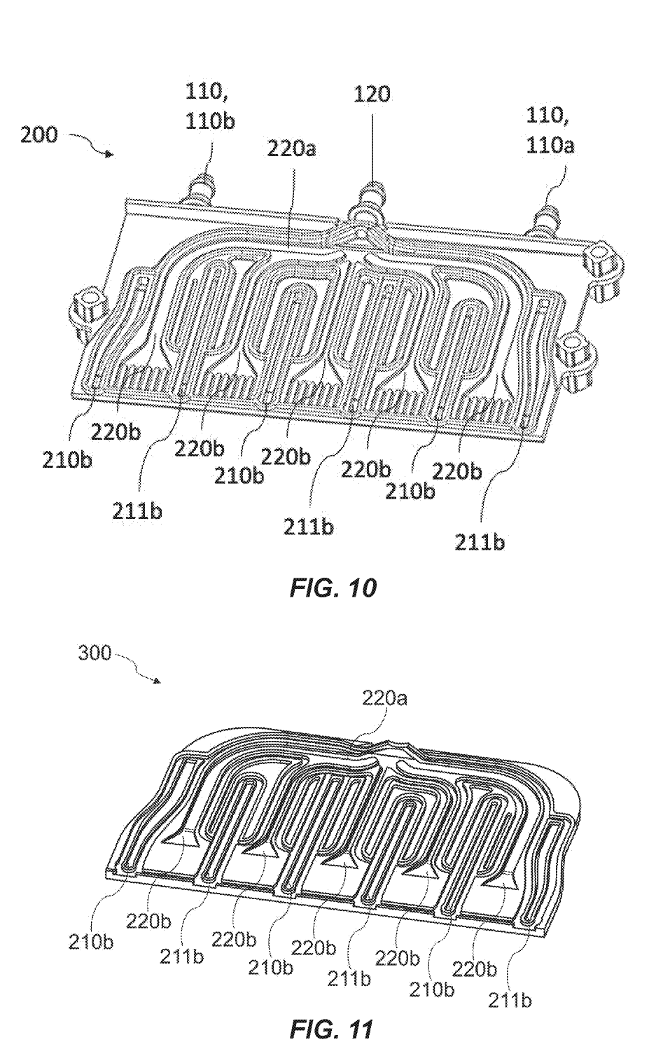

As an example, the even set of second channels can comprise even second distribution channels 210a and an even second distribution line 210b, and the odd set of second channels can comprise an odd second distribution channels 211a and an odd second distribution line 211b (FIGS. 9-11).

As an example, the even second distribution line 210b and the odd second distribution line 211b are formed on one of the first interface and the second interface, while the even second distribution channels 210a and the odd second distribution channels 211a are formed on the other of the first interface and the second interface.

The even second distribution line 210b and the odd second distribution line 211b can be molded on a face of one and/or the other of the first plate and the second plate forming the first interface, and while the even second distribution channels 210a and the odd second distribution channels 211a can be molded on a face of one and/or the other of the second plate and the third plate forming the second interface.

Even second through holes can be formed on the second plate to fluidically connect the even second distribution channels with the even second distribution line, and odd second through holes can be formed in the second plate to fluidically connect the odd second distribution channels with the odd second distribution line.

Whatever the considered embodiment, the two second inlets and the first inlet are formed on one or the other of the first face and the second face. Alternatively, the two second inlets and the first inlet can be formed on a contour joining the first face and the second face.

The second plate can comprise at least one passage fluidically connecting at least one of the two second inlets and the first inlet respectively, to the second channels and the first channels.

The present disclosure also concerns a fluid delivery assembly comprising:
the cleaning device according to the present disclosure;
a gas source connected to the first inlet;
a liquid source connected to the at least one second inlet; and
valves arranged for selectively feed the at least one second inlet with the liquid of the liquid source and the first inlet with the gas of the gas source.

The present disclosure also concerns an automotive vehicle comprising at least one sensor, the sensor having an exposed surface, the sensitive surface, the automotive vehicle being provided with at least one fluid delivery assembly according to the present disclosure, wherein the at least one delivery assembly being arranged for cleaning and drying the sensitive surface.

What is claimed is:

1. A cleaning device configured to dispense two fluids. respectively, a first fluid and a second fluid, the cleaning device comprising, alternatively disposed along a main direction of a face, a spraying face, a series of first outlets and second outlets, each series of first outlets comprising first outlets, the first outlets of a series of first outlets comprising main first outlets configured to spray the first fluid along a spraying direction perpendicular to the main direction and two lateral first outlets configured to spray the first fluid along, respectively, a first lateral direction and a second lateral direction, diverging from each other in a plane formed by the spraying direction and the main direction.

2. The cleaning device of claim 1, further comprising a first inlet and first channels, the first channels fluidically connecting the first inlet to the first outlets.

3. The cleaning device of claim 1, wherein the second outlets are arranged in two sets of second outlets, respectively, an even set of second outlets and an odd set of second outlets, each set of second outlets being configured to spray the second fluid independently from the other set of second outlets.

4. The cleaning device of claim 3, further comprising two second inlets, respectively, an even second inlet and an odd second inlet, the cleaning device further comprising two sets of second channels, respectively, an even set of second channels and an odd set of second channels, the even set of second channels fluidically connecting the even second inlet to the even set of second outlets, the odd set of second channels fluidically connecting the odd second inlet to the odd set of second outlets.

5. The cleaning device of claim 1, further comprising a stack of at least two plates, the stack comprising two main faces opposite to each other.

6. The cleaning device of claim 5, wherein the at least two plates of the stack of at least two plates comprise a plastic material.

7. The cleaning device of claim 5, wherein the plates of the stack of at least two plates are assembled so that an interface between at least two plates is hermetically sealed.

8. The cleaning device of claim 5, wherein the at least two plates comprise, from one main face defining a first face, to the other main face defining a second face, a first plate, a second plate and a third plate, the stack comprising a first interface between the first plate and the second plate, and a second interface between the second plate and the third plate.

9. The cleaning device of claim 8, further comprising a first inlet and first channels, the first channels fluidically connecting the first inlet to the first outlets, wherein the second outlets are arranged in two sets of second outlets, respectively, an even set of second outlets and an odd set of second outlets, each set of second outlets being configured to spray the second fluid independently from the other set of second outlets, the cleaning device further comprising two second inlets, respectively, an even second inlet and an odd second inlet, the cleaning device further comprising two sets of second channels, respectively, an even set of second channels and an odd set of second channels, the even set of second channels fluidically connecting the even second inlet to the even set of second outlets, the odd set of second channels fluidically connecting the odd second inlet to the odd set of second outlets, wherein the even set of second channels comprise even second distribution channels and an even second distribution line, the odd set of second channels comprise odd second distribution channels and an odd second distribution line.

10. The cleaning device of claim 9, wherein the even second distribution line and the odd second distribution line are formed on one of the first interface and the second interface, and the even second distribution channels and the odd second distribution channels are formed on the other of the first interface and the second interface.

11. The cleaning device of claim 10, wherein even second through holes are formed on the second plate to fluidically connect the even second distribution channels with the even second distribution line, and odd second through holes are formed in the second plate to fluidically connect the odd second distribution channels with the odd second distribution line.

12. The cleaning device of claim 9, wherein first channels comprise first distribution channels and a first distribution line, the first distribution line is formed on one of the first interface and the second interface, while the first distribution channels are formed on the other of the first interface and the second interface.

13. The cleaning device of claim 12, wherein first through holes are formed on the second plate to fluidically connect the first distribution channels with the first distribution line.

14. The cleaning device of claim 9, wherein the first channels comprise first distribution channels and a first distribution line, the first distribution line and the first distribution channels are formed either on the first interface or on the second interface.

15. The cleaning device of claim 9, wherein two second inlets and a first inlet are formed on one or the other of the first face and the second face.

16. The cleaning device of claim 15, wherein the second plate comprises at least one passage fluidically connecting at least one of the two second inlets and the first inlet respectively, to the second channels and the first channels.

17. The cleaning device of claim 1, further comprising a stack of three plates, the stack comprising two main faces opposite to each other, wherein the stack of three plates comprises, from one main face defining a first face, to the other main face defining a second face, a first plate, a second plate and a third plate, the stack comprising a first interface between the first plate and the second plate, and a second interface between the second plate and the third plate, wherein the stack of three plates has a thickness less than 15 mm, a length less than 200 mm, and a width less than 80 mm.

18. The cleaning device of claim 1, wherein the first outlets within each series of first outlets are arranged in a periodic manner along the main direction.

19. A fluid delivery assembly comprising:
at least one cleaning device according to claim 1;
a first fluid source; and
a second fluid source.

20. An automotive vehicle comprising at least one sensor, the sensor having an exposed surface defining a sensitive surface, the automotive vehicle including at least one fluid delivery assembly according to claim 19, wherein the at least one delivery assembly is arranged for cleaning and drying the sensitive surface.
